(19) United States
(12) Patent Application Publication
(10) Pub. No.: US 2002/0159667 A1
(43) Pub. Date: Oct. 31, 2002

(54) Waveguide optimization for maximum-sensitivity poled polymer electro-optic modulator

(76) Inventors: Timothy Edwin Van Eck, Los Altos, CA (US); Lawrence Joseph Dries, Santa Clara, CA (US); Rebecca Ellen Taylor, San Carlos, CA (US); Wendell Douglas Eades, Sunnyvale, CA (US); Angelina Sandra Moss, Morgan Hill, CA (US)

Correspondence Address: SWIDLER BERLIN SHEREFF FRIEDMAN, LLP, 3000 K STREET, NW, BOX IP, WASHINGTON, DC, 20007, US

(21) Appl. No.: 10/120,137

(22) Filed: Apr. 11, 2002

Related U.S. Application Data
(60) Provisional application No. 60/282,873, filed on Apr. 11, 2001.

(51) Int. Cl. G02F 1/035

(52) U.S. Cl. 385/2

(57) ABSTRACT

A method of optimizing for achieving maximum sensitivity for poled polymer electro-optic modulator is given by maximizing confinement of optical power in the electro-optic core layer and maximizing lateral field attenuation coefficient in the modulator cladding material.

This application is based on Provisional Application No. 601282,873 filed Apr. 11, 2001.

### FIELD OF THE INVENTION

The present invention relates to optical waveguides and optimization thereof. More particularly this invention pertains improvements in efficiency and effectiveness.

### BACKGROUND OF THE INVENTION

There are many methods used to optimize performance of optical waveguides such as, for example, lasers and polymer waveguides.

An important figure of merit for an electro-optic modulator is the half-wave voltage, and smaller values of the half-wave voltage are preferable. The half-wave voltage of an electro-optic modulator at the particular optical wavelength is determined by the electro-optic coefficient of the confirming material, the length of the electro-optically modulated waveguide, and the ratio between an applied voltage and the strength of the modulating electric field inside the electro-optic core material, and also the optical-electrical overlap integral, and the core refractive index if the core dielectric constant is different from that of the cladding layers.

With the electro-optical coefficient independently maximized, the length limited by consideration of optical loss and frequency response, the wavelength being consistent, and the overlap integral and refractive index being nearly constant, the optimum modular performance, defined as minimum half-wave voltage, is obtainied by maximizing the electric field strength for a given applied voltage, which is obtained in turn by choosing the minimum total polymer thinkness that can propagate light at the operating wavelength without significant optical propagation loss by resistive absorption of the optical field in the metal drive electrodes.

### SUMMARY OF THE INVENTION

The techniques and methods of this invention have been found to be useful optimizing waveguide materials and structure to achieve the maximum sensitivity poled polymer electro-electric modulators.

It is an object of this invention to optimize waveguide structure and materials.

It is yet another object of this invention to find ways of selecting systems that demonstrate the maximum sensitivity in poled polymer electro-optic modulators.

Also, the systems achieved by this invention are more effective and, thus, can be less costly than the prior art developed systems.

The objects of this invention can achieved by measuring materials to achieve a figure of merit for an electro-optical modulator of minimum half-wave values.

### DESCRIPTION OF THE DRAWINGS

FIG. 1 is a three-dimensional waveguide diagram.

FIG. 2 is a top view of a modulator.

FIG. 3 is an edge view of an electro-optic waveguide.

FIG. 4 is an edge view of optical field in the waveguide.

### DETAILED DESCRIPTION OF THE INVENTION

The benefits and advantages of this invention provides waveguides which can be optimized for generally use and well as specific applications.

An important figure of merit for an electro-optic modulator is the half-wave voltage, and smaller values of the half-wave voltage are preferable. The half-wave voltage of an electro-optic modulator at the particular optical wavelength is determined by the electro-optic coefficient of the confirming material, the length of the electro-optically modulated waveguide, and the ratio between an applied voltage and the strength of the modulating electric field inside the electro-optic core material, and also the optical-electrical overlap integral, and the core refractive index if the core dielectric constant is different from that of the cladding layers.

With the electro-optical coefficient independently maximized, the length limited by consideration of optical loss and frequency response, the wavelength being consistent, and the overlap integral and refractive index being nearly constant, the optimum modular performance, defined as minimum half-wave voltage, is obtainied by maximizing the electric field strength for a given applied voltage, which is obtained in turn by choosing the minimum total polymer thinkness that can propagate light at the operating wavelength without significant optical propagation loss by resistive absorption of the optical field in the metal drive electrodes.

Such optimization is achieved by first maximizing confinement of optical power in the electro-optic core layer, thereby maximizing the lateral field attenuation coefficient in the cladding material which in turn achieved maximization of the optical refractive index difference between the core and cladding layer. This is achieved by maximizing the percentage of chromophore material in the core material and by choosing an optimum core layer thickness that maximizes the lateral field attenuation coefficient with contributing excess layer thickness. It is also appropriate to reducing the cladding thickness to a value at which the optical absorption is acceptable, but any lesser thickness would cause unacceptably high optical absorption.

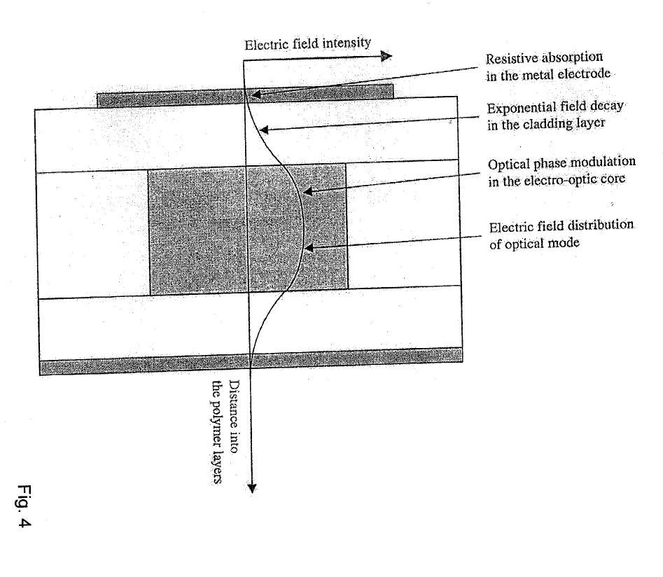

In FIG. 4 the optical electric field intensity throughout the polymer layer is graphed. The electric field inside the core layer contributes to electro-optic modulation, so as much of the electric field as possible should be confined to the core layer, by maximizing the refractive index of the core layer relative to the cladding layers. The electric field in the cladding layers is attenuated with increasing distance from the core.

The electric field in the metal electrode layers is absorbed by the metal resistively so the electric field in the metals layers should be minimized. This is accomplished in two ways. First by maximizing the lateral attenuation coefficient of the electric field which is in turn done by maximizing the difference of refractive index between the core and the cladding layers. Second, it is appropriate to maximize the thickness of the cladding layers, which has the undesirable effect of increasing the total polymer thickness, and thus increasing the modulator half-wave voltage. Thus, the optimum balance between low half-wave voltage and low optical loss is achieved by increasing the core refractive index, or decreasing the cladding refractive index to the extent possible. Then one should reduce the cladding thickness until the optical absorption loss is just be low the acceptable threshold.

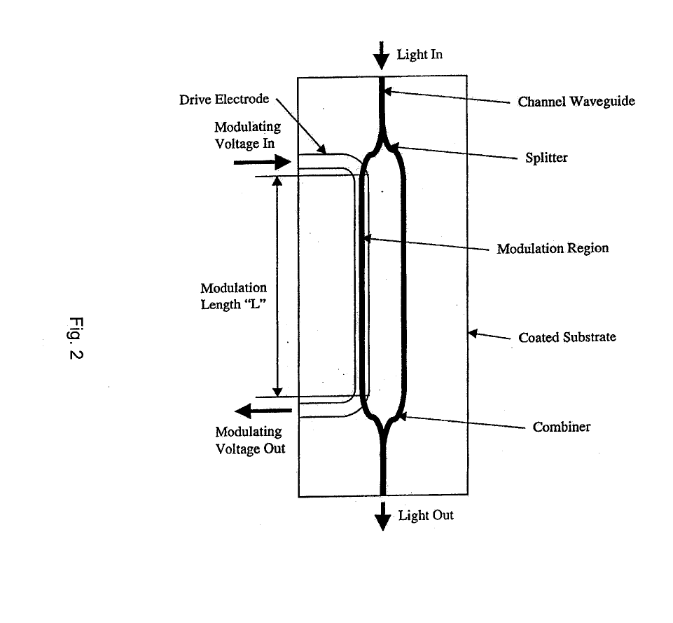

FIG. 2 shows a modulator in a Mach-Zehnder configuration with light entering a channel waveguide being split by a splitter, modulated in a straight wave guide, recombined in a recombiner, and then exiting the channel waveguide. Of course the invention applies to other modulator configurations including straight phase modulators and directional coupler switches among others. In addition, with a modulating electrode over each arm of a Mach-Zehnder modulator, a frequency mixing function can be achieved by applying signals with two different frequencies to the two modulator arms.

Other functions may be done including phase modulation, intensity modulation, and frequency mixing can be optimized by this invention.

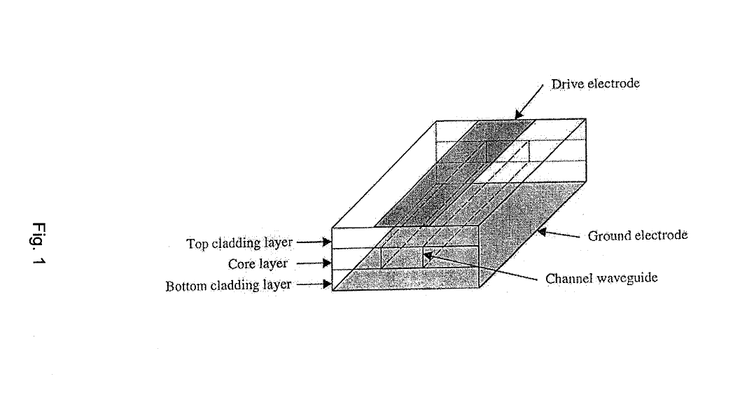

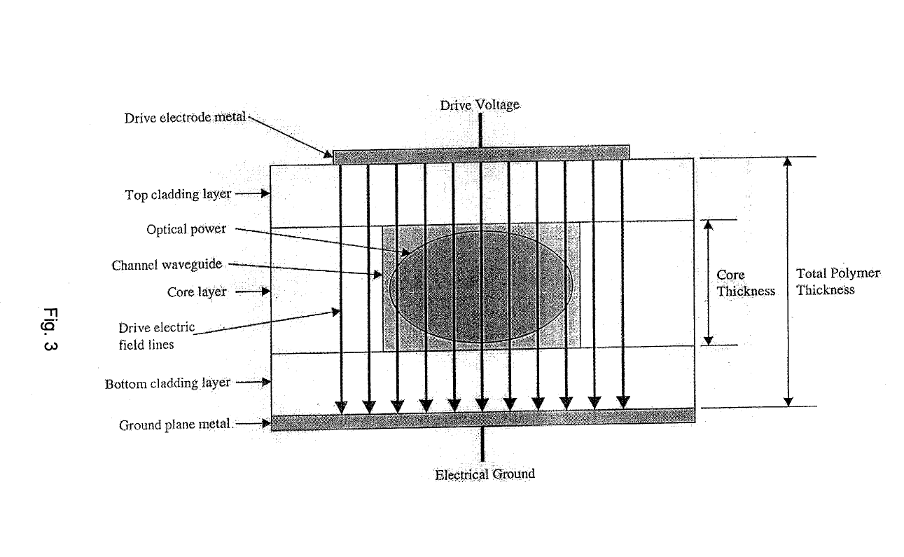

FIGS. 1, 3, and 4 show a channel waveguide defined by a rectangular section of different refractive index than the top and bottom cladding layers and the lateral cladding region. But the invention also applies to other structures that function as channel waveguides, including but not limited to etched rib waveguides and etched trench waveguides. Any type of channel waveguide can be used which provides lateral confinement of light and also has cladding material above and below the confinement region

In applications using radio frequency distribution and frequency shifting, the gain and dynamic range of the radio frequency link or frequency shifter increase which improves as the modulator half-wave voltage decreases, and as the optical insertion loss decreases. The noise figure decreases or improves as the modulator half-wave voltage decreases, and as the optical insertion loss decreases.

In modulator design, the balance between the low half-wave voltage and low optical insertion loss and the invention improves the modulator half-wave voltage without degrading the optical insertion loss.

For applications which may be digital in character, the invention minimizes the switching voltage which generally minimizes electrical drive power. In specific systems this would reduce the switching voltage below the threshold needed for compatibility with high-speed electronics without degrading optical loss, which would case increased optical drive power.

By the higher refractive index of the core material, a more efficient modulation can be achieved because of stronger confinement of the light to the core layer and more rapid attenuation of the optical field in the cladding layer. Moreover, a more efficient modulation is achieved because of the larger electric field in the electro-optical core layer. Thus a high core refractive index (e.g. 1.617) relative to the cladding can be achieved with minimum thickness of both cladding layers and core layers.

While the preferred embodiments of the present invention have been described above, it should be understood that they have been presented by way of example only, and not of limitation. It will be apparent to persons skilled in the relevant art that various changes in form and detail can be made therein without departing from the spirit and scope of the invention. Thus the present invention should not be limited by the above-described exemplary embodiments.

What is claimed is:

1. A method of optimizing for achieving maximum sensitivity for poled polymer electro-optic modulator comprising maximizing confinement of optical power in the electro-optic core layer and maximizing lateral field attenuation coefficient in the modulator cladding material.
